(19) United States
(12) Patent Application Publication
(10) Pub. No.: US 2008/0046336 A1
(43) Pub. Date: Feb. 21, 2008

(54) SCHEDULE-BASED ELECTRONIC MARKETPLACE FOR SERVICES

(76) Inventor: Mohsen Mosleh, Bethesda, MD (US)

Correspondence Address: MAXVALUEIP CONSULTING, 11204 ALBERMYRTLE ROAD, POTOMAC, MD, 20854, US

(21) Appl. No.: 11/839,534

(22) Filed: Aug. 15, 2007

Related U.S. Application Data
(60) Provisional application No. 60/822,592, filed on Aug. 16, 2006.

(51) Int. Cl. G06Q 30/00

(52) U.S. Cl. 705/26

(57) ABSTRACT

A schedule-based, neighborhood-based electronic marketplace for services is presented here. The electronic marketplace allows users to make use of their time, such as their spare time, to offer, sell, or trade services to other users in their selected neighborhoods. Users can also search the electronic marketplace to buy or trade services in their selected neighborhoods. In addition, users other than individuals, such as companies, can use all services offered by the electronic market place. One way to mark neighborhoods for the electronic market place is the use of postal zip codes. This includes registration, search, advertising, e-commerce, user-ranking, and user-interaction. It contains user profile, necessary database, password, and other necessary information, such as usage of encryption, watermarking, DRM, PKI, RFID, or biometrics. It contains a search engine to allow looking for specific services in selected time and locations. It allows users to advertise their service offerings in selected neighborhoods at selected time. It contains scheduling, job category, and service pricing information. It allows commission-based transactions in the marketplace (or referral fees/finder's fee). It also allows service to trade between users. It allows service providers and receivers to rank each other based on the desired factors. It allows interaction of users electronically.

### RELATED APPLICATION

This application is related to a provisional application, Ser. No. 60/822,592, filed on Aug. 16, 2006, by the same inventor, on the same subject.

### BACKGROUND

The present invention relates generally to electronic marketplaces, and more specifically, it relates to a schedule-based, neighborhood-based electronic marketplace for services. The electronic marketplace designed and operated according to this invention allows users to make use of their time, such as their spare time, to offer, sell, or trade (or swap, with or without money) services to other users in selected time and neighborhoods. Users can also search the electronic marketplace to buy or trade services in selected time and neighborhoods. In addition, users other than individuals, such as companies, can use all services offered in the electronic marketplace. One way to mark neighborhoods for the electronic marketplace is the use of postal zip codes, or radius/distance from a center of interest.

With advances of mobile communications and related software and hardware technologies permitting users to manage their time efficiently, this platform enables users to utilize their spare time to offer/receive services in incremental time periods. i.e. hourly or sub-hourly periods, effectively and economically.

There are some related prior art in this industry:

Koenig, U.S. Pat. No .7,167,855.

Jacob, U.S. Pat. No. 7,224,781.

Ruvolo, U.S. Pat. No. 6,978,246.

Gupta, U.S. Pat. No. 7,216,093.

Beaudoin, U.S. Pat. No. 7,096,193.

Lu, U.S. Pat. No. 7,039,596.

www.sparetimesbowling.com

Sologig.com

Groovejob.com

Jobfox.com

Weekendhandyman.com

virtualassisstantjobs.com

care.com

craigslist.com

sellingstufflocal.com

Monster.com

Plumber.com

Aol.careerbuilder.com

Match.com

Natmatch.com

www.angieslist.com

www.oodle.com

However, none of the above teaches the features taught here in this invention.

Electronic marketplaces are widely used in today's society. Typically, electronic marketplace are comprised of online stores through which users can buy, sell, or trade goods and services, online recruitment and job search services through which users can advertise their expertise for hire on a full-time, part-time basis, or project-based models, and fee-paid matching systems based on a variety of criteria and algorithms including ranking and other weighted factors. Also, in prior art, one can find instances which permit users to make reservations in some electronic marketplaces for receiving certain services or to collaborate with others in event calendaring systems.

The main problem with conventional electronic marketplaces is that they do not offer a self-serve platform to allow users to offer, sell, and receive services to and from other users in their desired time and selected locations. However, this electronic marketplace platform treats users' time as a commodity that can be scheduled in increments such as minutes and hours, during which the user can provide certain services in a self-managed manner. Another problem with conventional electronic marketplaces is that they do not allow users to trade services with other users in their desired time, which can be their spare time, in their neighborhood, which in one way may be defined by its postal zip code. Other location distinctions methods are by region, city, natural boundaries, political boundaries, time zones, or geographical zones. GPS and Internet protocol address systems can be implemented here, as well.

In these respects, the schedule-based, neighborhood-based electronic marketplace for services according to the present invention substantially departs from the conventional concepts and designs of the prior art, and in so doing, provides an apparatus primarily developed for the purpose of serving as a self-serve platform for allowing the users to make use of their time, such as their spare time, to offer, sell, or trade services to other users in selected neighborhoods.

### SUMMARY

In view of the foregoing disadvantages inherent in the known types of electronic marketplace now present in the prior art, the present invention provides a new schedule-based, neighborhood-based electronic marketplace for services which allows users to make use of their time, such as their spare time, to offer, sell, or trade services to other users in their selected neighborhoods. Users can search the electronic marketplace to buy or trade services in selected neighborhoods in incremental time units. In addition, users other than individuals, such as companies, can use all services offered by the electronic market place. One way to mark neighborhoods for the electronic marketplace is the use of postal zip codes.

To attain this, the present invention generally comprises registration, search, advertising, ecommerce, user ranking, and user interaction, as options. It contains user profile, necessary database, password, and other necessary information. It contains a search engine to allow looking for specific services in selected time and locations. It allows users to advertise their service offerings in selected neighborhoods at selected time. It contains scheduling, job category, and service pricing information. It allows service providers and receivers to rank each other based on the desired factors. It allows interaction of users electronically. It allows issuing the certificate entitling to the future services. It allows issuing a gift certificate, e-coupon, and rebate.

Another object is to provide a schedule-based, neighborhood-based electronic marketplace for services that enables users to buy, sell, or trade services online in selected neighborhoods at agreed time and period, based on the ranking or preference of the user on the allocated times.

Another object is to provide a schedule-based, neighborhood-based electronic marketplace for services that enables users to advertise services online (or search) in selected neighborhoods at selected time and period.

### BRIEF DESCRIPTION OF THE DRAWINGS

FIG. 1: The architecture of Spare Time Market Website

FIG. 2: User-STM Website interaction diagram for finding or posting services

FIG. 3: Spare Time Market Data Center

FIG. 4: Search engine

FIG. 5: Communication between the service client and the service provider

FIG. 6: Feedback system

FIG. 7: User-STM Website interaction diagram for user profile

FIG. 8 shows overall layout of the homepage.

FIG. 9 shows new user registration.

FIG. 10 shows how to post a new service.

FIG. 11 shows search for service.

FIG. 12 shows display search results.

FIG. 13 shows display service.

FIG. 14 shows contact service provider.

FIG. 15 shows rank the service provider.

### DETAILED DESCRIPTION OF THE PREFERRED EMBODIMENTS

The current invention has many embodiments/examples/variations/features:
Self-serve, schedule-based, fixed-price model. The electronic marketplace designed and operated according to this invention allows users to make use of their time, such as their spare time, to offer, sell, or trade (or swap, with or without money) services to other users in selected time and neighborhoods at a specified price or rate.
Spare Time Auction. Users would bid on the specific times/services of the service providers. Initially, the service providers may not get as much money for their services (we can have a minimum price to reduce the risk of someone bidding $1 for a service), however, getting a high rating could generally create higher bids. The reverse auction, anonymous, or other auctions can be employed, as well.
Name-Your-Price. The users would tell the system how much they want to pay for the services, and the system would find a match. The system may (or may not) be able to negotiate a price with the service providers, by the web site, or by the other user, directly.

The last 2 options may only be useful when the service providers do not publish prices, or are flexible on their charges.

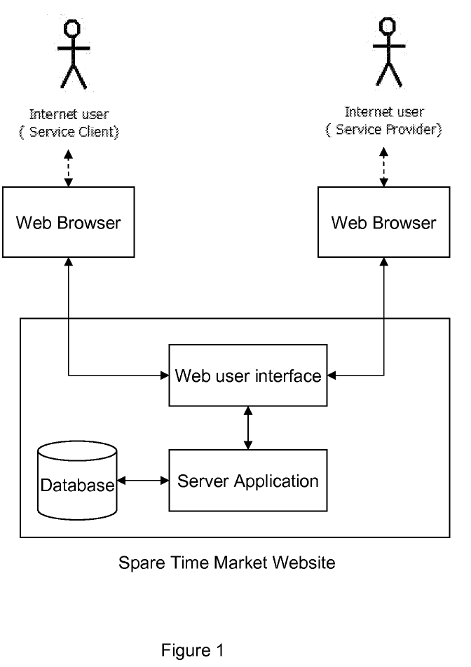

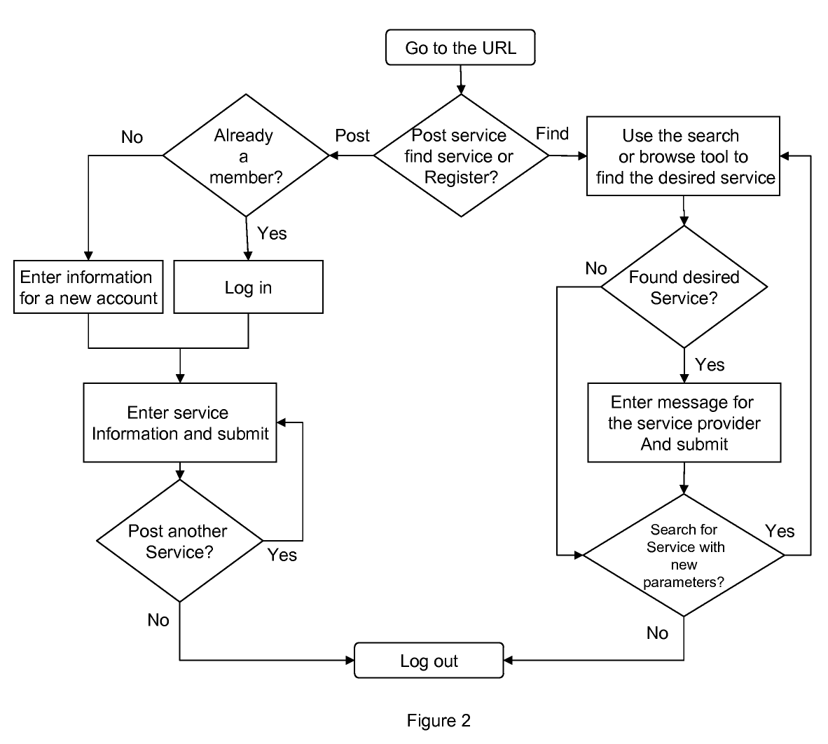

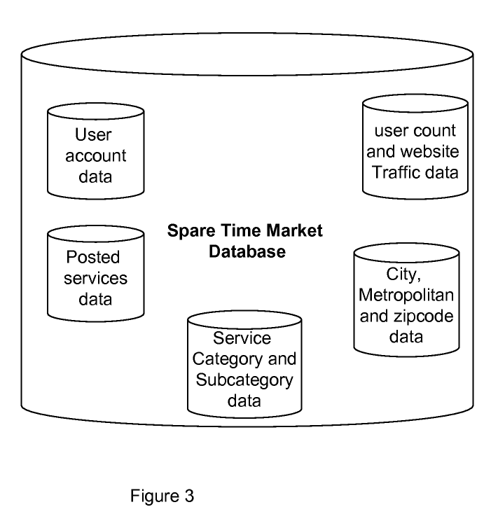

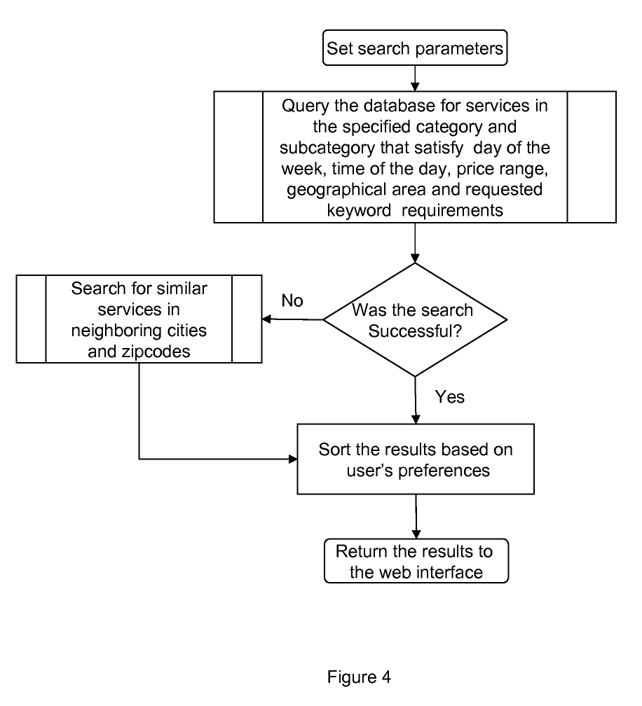

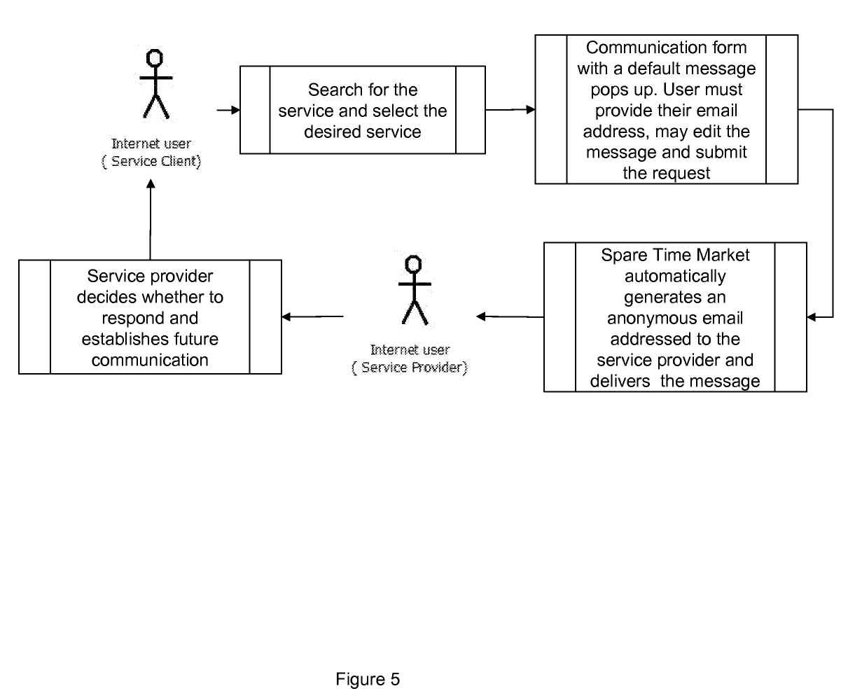

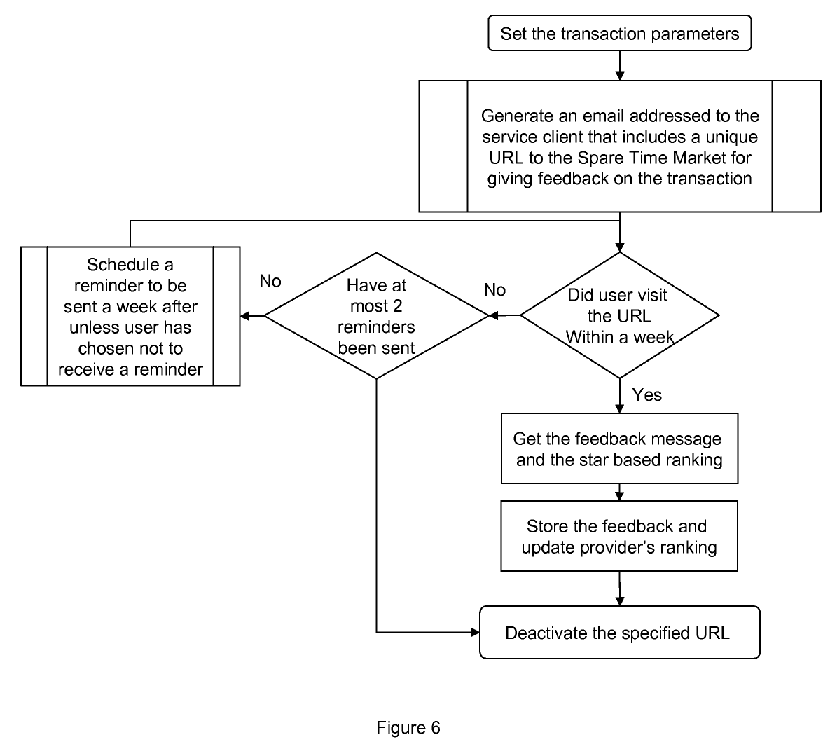

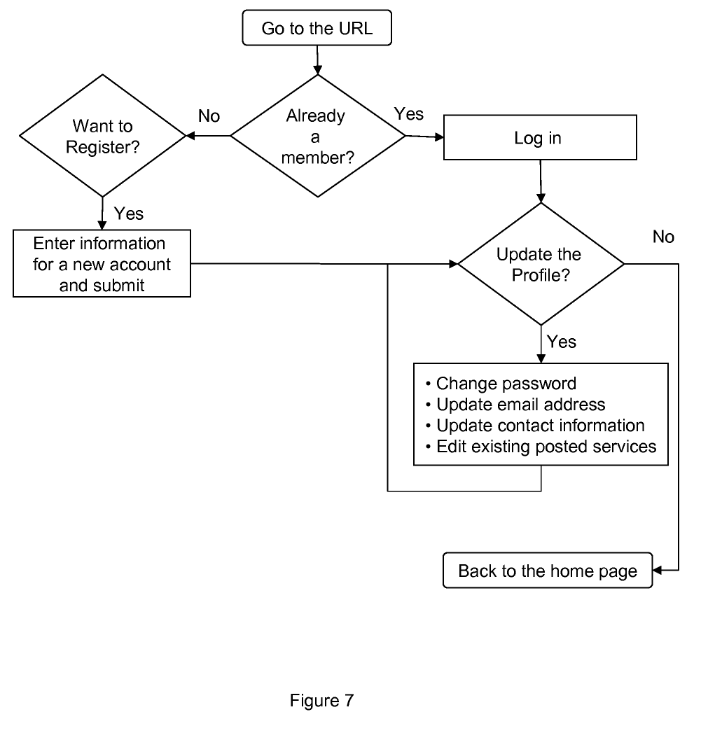

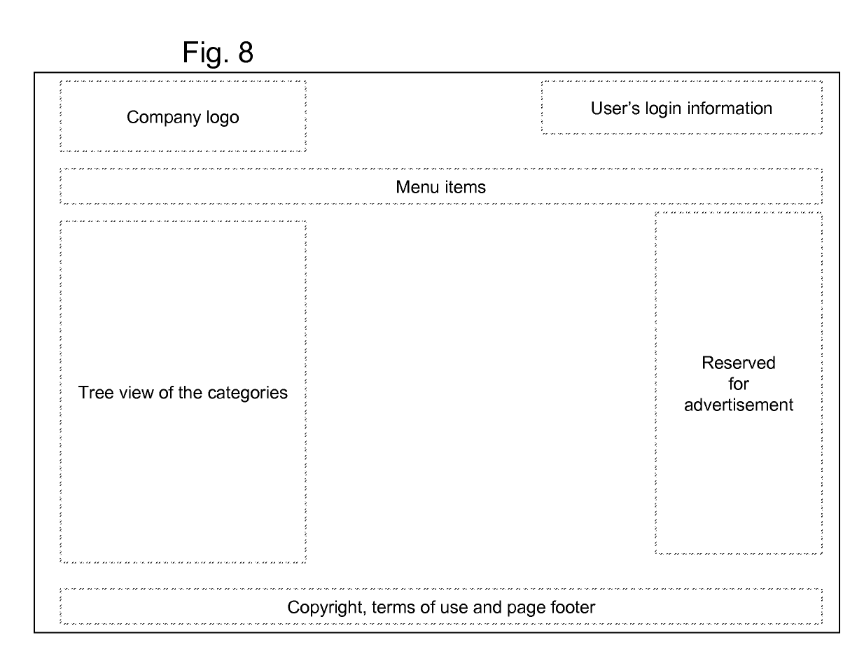

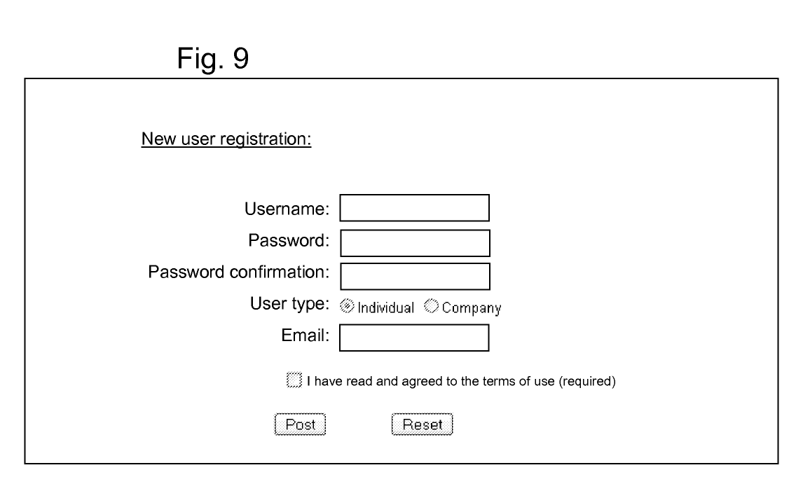

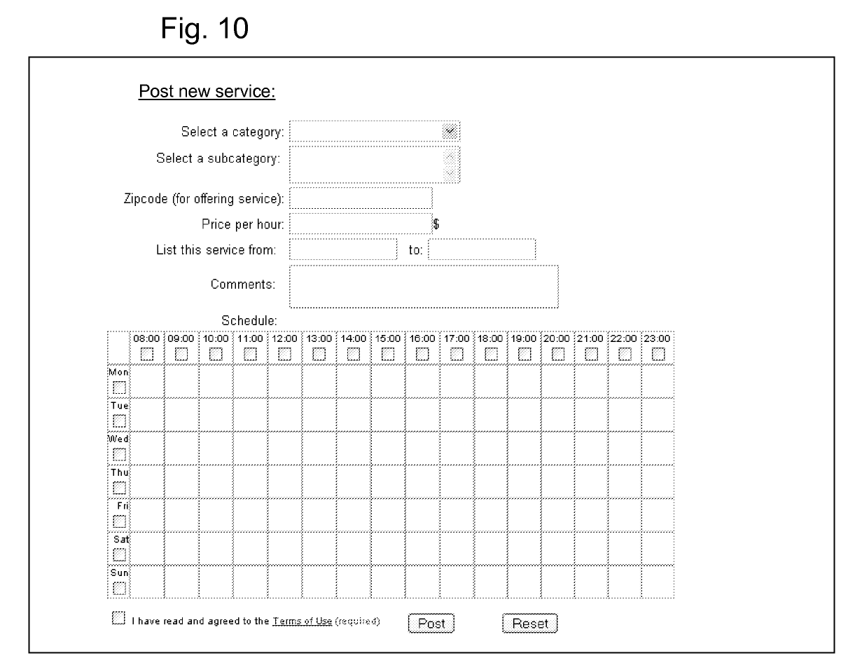

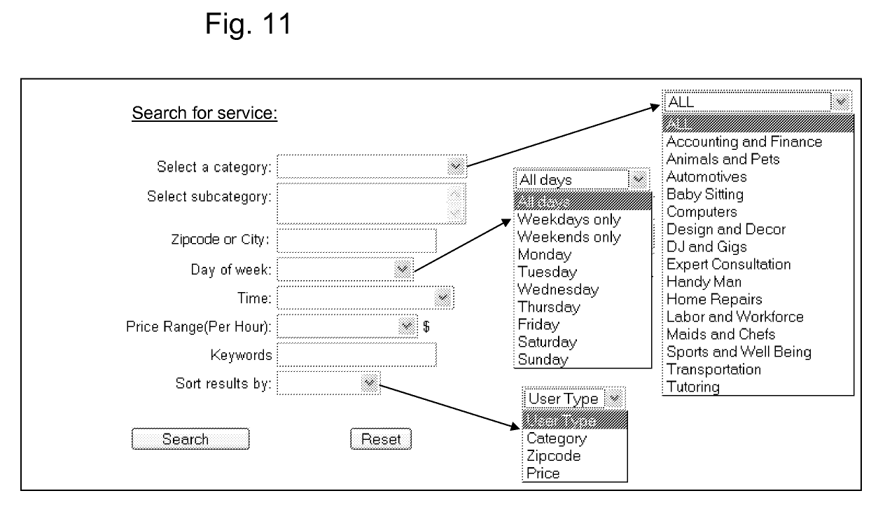

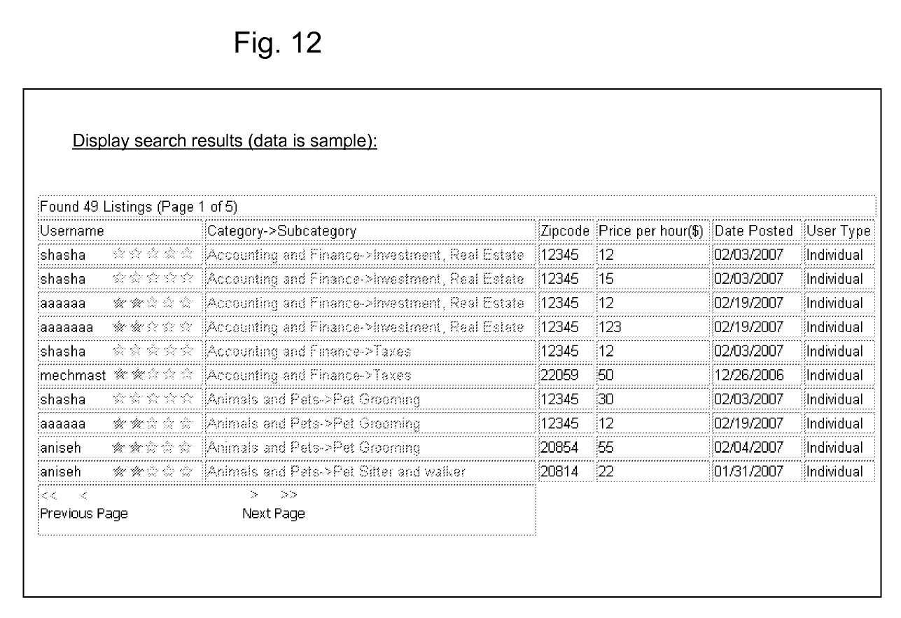

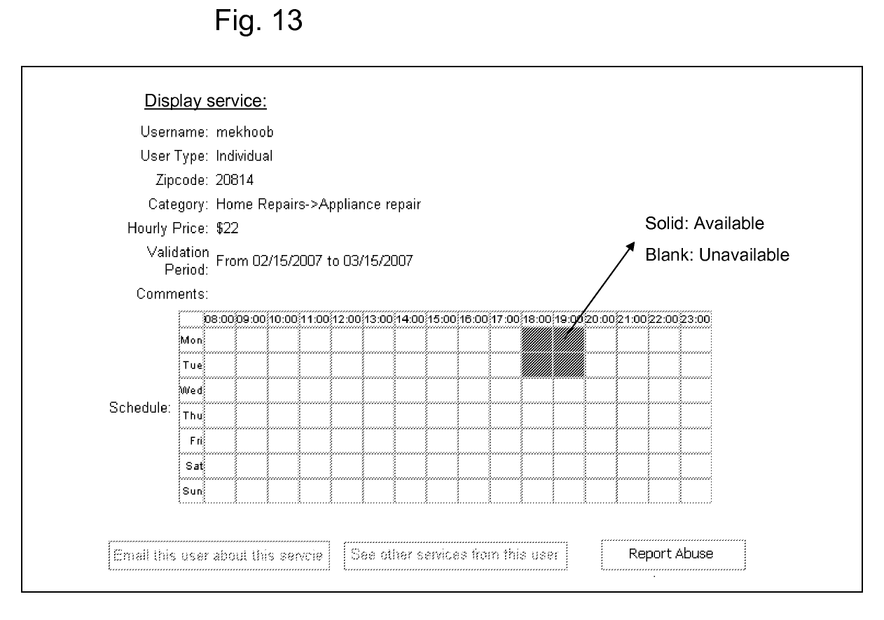

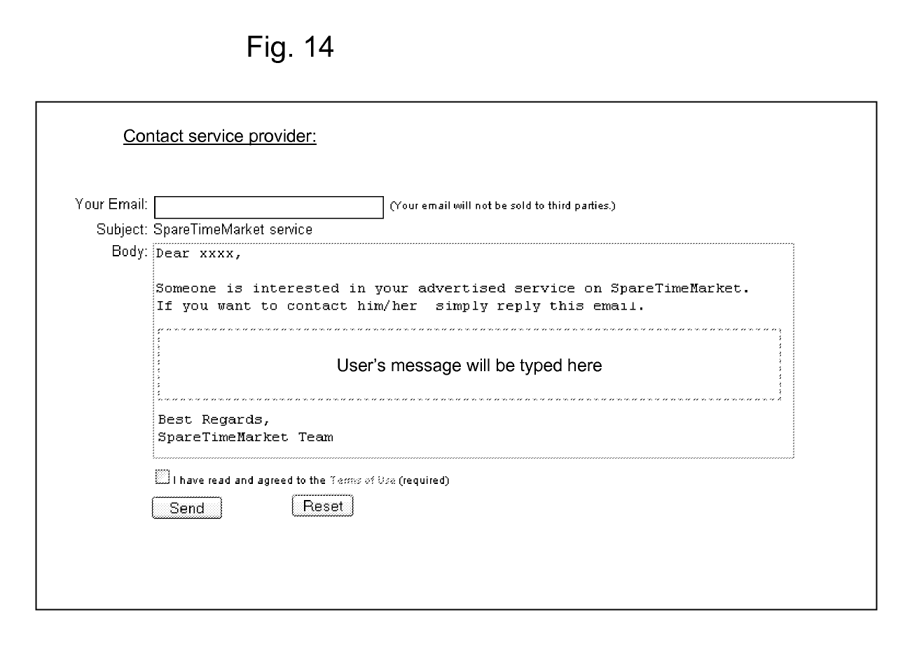

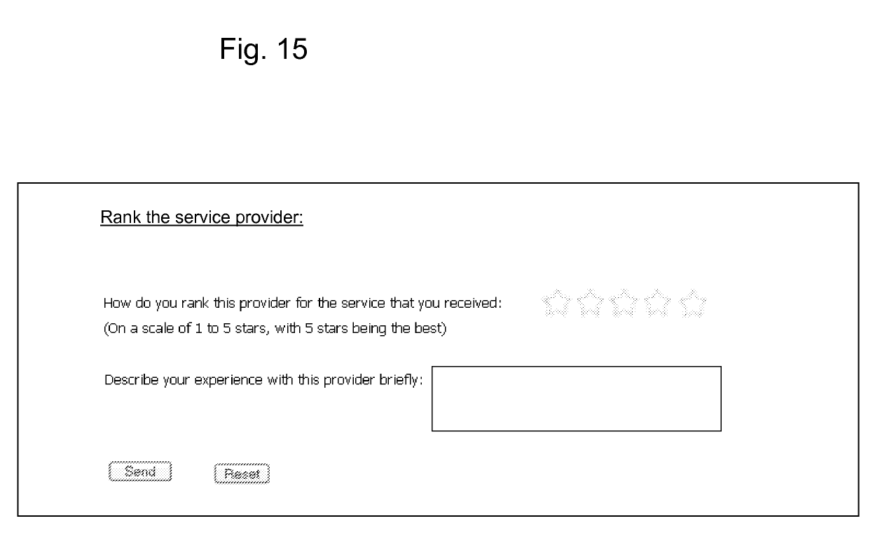

FIGS. 1-15, as one example, show the architecture of Spare Time Market (e.g. our system, named STM) Website, User-STM Website interaction diagram for finding or posting services, Spare Time Market Data Center, Search engine, Communication between the service client and the service provider, Feedback system, User-STM Website interaction diagram for user profile, overall layout of the homepage, new user registration, how to post a new service, search for service, display search results, display service, contact service provider, and rank the service provider, respectively.

The services can be exchanged, as in stock markets, between users, as well, based on electronic certificates, which entitles the owner, for example, for 2 hours of service by another user. This can act as a gift certificate, as well, to assign or transfer the ownership. This will produce another set of market and economy.

Our system can also work with a dynamic schedule update feature which tracks changes of available incremental time units offered by the service providers, or imported or exported between different formats and systems. It can synchronize with other calendars, such as the one in the PDAs or cell phones. It can work based on or as a business-to-business, business-to-consumer, or consumer-to-consumer model.

The schedule-based, neighborhood-based electronic marketplace for services comprises registration, search, advertising, e-commerce, user ranking, and user interaction. It contains user profile, necessary database, password, and other necessary information. It contains a search engine to allow looking for specific services in selected time and locations. It allows users to advertise their service offerings in selected neighborhoods at selected time. It contains scheduling, job category, and service pricing information. It allows commission-based transactions in the marketplace. It also allows service trade between users. It allows service providers and receivers to rank each other based on the desired factors. It allows interaction of users electronically.

Registration may involve optional or required information. The search capabilities of the marketplace can be extended to desired users' criteria, as customized search. It contains scheduling, job category, and service pricing information. The scheduling part can be done on sub-hourly, hourly, daily, weekly, monthly or annual basis. It can include extended calendar. The ranking system is used by users of services and can be star or number based, with history, total number, average, comments, judged comments, filtered comments, chain of comments, and the usual credit history rating. It allows interaction of users electronically. Users' interaction may be done by email, phone, or mail, if users select these options.

Users enter the website of the electronic marketplace and enter the desired postal zip code of the neighborhood in which they are looking for services or interested to offer services at specific intervals of time in daily, weekly, or monthly schedules. The users can look for services offered by other users, buy them, or trade with their own services. They can choose services based on price, proximity, or ranking. Before advertising on the marketplace, users are requested to register. The search capabilities of the marketplace allow users to look for desired service in selected neighborhoods at desired time and engage in communication and transaction with other users. The service providers and receivers are able to rank each others after trading services. This can be reminded to them by e-mail after a certain period, or periodically. The revenue and value for the service can be based on the transaction amount, transaction number, with or without thresholds, with or without ramping, ads, referral, click numbers, value as a portal, marketing, social networking, trend studies, business focus, peer-to-peer, viral marketing, and cross-marketing.

The platform can have video and picture commentary or sample of work, or have a link to a reference for verification and checking the quality of the prior services. The contact can be done by the platform, or directly between users. It would filter inappropriate comments, text, and images, by human or machine filtering. It will filter spams and anything that collects information automatically for a third-party. It can block the calendars, once an appointment is set, so that a second user will not try to (and cannot) set up a time at exactly the same time.

User can be a volunteer, and the price can be zero. The system can be done in real life or in virtual environments, such as in Second Life.

The self-serve system has the following steps: match(es) are displayed to a second user so that the second user may choose which, if any, of the service offering listed by the system are suitable, and if the second user selects a match, the system will facilitate a communication between the first user and the second user, so they can further explore the match and a service arrangement.

Any variations of the teachings above are meant to be covered by the current application.

1. A system for schedule-based, geographical-based electronic marketplace for services, said system comprising:
an input module where a first user can register,
a first interface module where said first user can specify what service said first user can provide, at which locations, and at which incremental time periods in a daily, weekly, or monthly schedule,
a second interface module where a second user can specify what service said second user needs, at which location, and at what incremental time periods in a daily, weekly, or monthly schedule, and
one or more databases where the information about users, time, location, and services are stored,
wherein said system searches said one or more databases to find zero, one, or more matches between said first user and said second user, based on the criteria or conditions specified by said first user and said second user.

2. A system for schedule-based, geographical-based electronic marketplace for services, as recited in claim 1, wherein said system comprises a module to generate a means of communication by and between said system, said first user, and said second user, using one or more of the following methods: electronic mail, instant message, phone, notification, warning, or regular mail.

3. A system for schedule-based, geographical-based electronic marketplace for services, as recited in claim 1, wherein said system comprises a calendar, dynamic calendar, or synchronized calendar.

4. A system for schedule-based, geographical-based electronic marketplace for services, as recited in claim 1, wherein said system comprises an auction module.

5. A system for schedule-based, geographical-based electronic marketplace for services, as recited in claim 1, wherein said system comprises a module which issues stocks or ownership certificates for the services offered in the future by a user.

6. A system for schedule-based, geographical-based electronic marketplace for services, as recited in claim 1, wherein said system is a distributed system.

7. A system for schedule-based, geographical-based electronic marketplace for services, as recited in claim 1, wherein said system uses fuzzy logic or neural network to match the users.

8. A system for schedule-based, geographical-based electronic marketplace for services, as recited in claim 1, wherein said system comprises a security module.

9. A system for schedule-based, geographical-based electronic marketplace for services, as recited in claim 1, wherein said system is a self-serve platform.

10. A system for schedule-based, geographical-based electronic marketplace for services, as recited in claim 1, wherein said system comprises a billing or payment module.

11. A system for schedule-based, geographical-based electronic marketplace for services, as recited in claim 1, wherein said system comprises a trading services module.

12. A system for schedule-based, geographical-based electronic marketplace for services, as recited in claim 1, wherein said system comprises a ranking, feedback, or comment module for the users.

13. A system for schedule-based, geographical-based electronic marketplace for services, as recited in claim 1, wherein said first user sets a price or a rate.

14. A system for schedule-based, geographical-based electronic marketplace for services, as recited in claim 1, wherein said system comprises a negotiation module.

15. A system for schedule-based, geographical-based electronic marketplace for services, as recited in claim 1, wherein said system comprises a web service.

16. A system for schedule-based, geographical-based electronic marketplace for services, as recited in claim 1, wherein said system comprises an agent-based service.

17. A system for schedule-based, geographical-based electronic marketplace for services, as recited in claim 1, wherein said system comprises a map.

18. A system for schedule-based, geographical-based electronic marketplace for services, as recited in claim 1, wherein said system comprises zoning areas or search focus areas based on geographical boundaries, political boundaries, street addresses, distances from a specific location, or Internet Protocol addresses.

19. A system for schedule-based, geographical-based electronic marketplace for services, as recited in claim 1, wherein said first user or said second user is an individual, company, business, or corporation.

20. A system for schedule-based, geographical-based electronic marketplace for services, as recited in claim 1, wherein said system comprises a name-your-price module.
